(19) United States
(12) Patent Application Publication
(10) Pub. No.: US 2005/0024025 A1
(43) Pub. Date: Feb. 3, 2005

(54) Method to prevent saturation of an inductor coil and inductor coil circuits for realising such a method

(75) Inventors: Joannes Mathilda Josephus Sevenhans, Brasschaat (BE); Elve Desiderius Jozef Moons, Lummen (BE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/879,015

(22) Filed: Jun. 30, 2004

(30) Foreign Application Priority Data
Jul. 1, 2003 (EP) 03291613.2

(51) Int. Cl. H02M 1/12

(52) U.S. Cl. 323/249

(57) ABSTRACT

A method to avoid saturation of the magnetic core (M) of an inductor coil (L) includes the steps of providing a bypass circuit (BP) across said inductor coil (L) for bypassing a DC current to said coil. Such a bypass circuit includes a regulating circuit (RE) to control the amount of DC current which is bypassed, and may further include an active gyrator (G) for the bypass of the DC current. This invention is applicable to one single coil (L) or to any circuit including a series connection of coils. In the latter case one or more bypass circuits may be provided across either one or more series connected coils.

The present invention relates to a method to prevent saturation of inductor coils as described in the preamble of claim 1.

Such a method is already known in the art, for instance in the published US patent application 2001/0006470. Therein a control circuit for a load in an automotive vehicle is described, comprising a chopping circuit, at least an LC filter, and means opposing the saturation of the inductor of the LC circuit. This means for opposing the saturation of the inductor is provided such as to prebias the inductor in a chosen direction. This is obtained by an auxiliary winding which is wound as one and the same element with the coil, around one and the same magnetic core. The auxiliary winding is permanently energized by a current directed in an opposite direction as that of the current through the primary winding. The auxiliary winding therefore induces an opposite magnetic field to that generated by the primary winding when this coil is traversed by the normal load current through this primary winding. The auxiliary coil is thus prebiased in a direction which increases the threshold beyond which the normal current through the primary winding saturates the coil. This auxiliary current is continuously kept in the same direction and with the same magnitude over time.

A drawback of such a method is that it uses an extra winding, which increases the volume of the total coil circuit, and that it needs an extra current through this extra winding, increasing the total power consumption of the coil circuit.

An object of the present invention is to provide a method to avoid saturation of the magnetic core of the coil, but without the mentioned drawbacks of the prior art methods.

According to the invention, this object is achieved due to the fact that said method includes the steps as described in claim 1.

In this way, the dc current flowing through the normal winding and which normally causes the saturation of the magnetic core, is bypassed through a bypass circuit. It is evident that such a solution does not consume an extra dc current, neither requires an extra winding around the magnetic core.

A further characteristic feature of the present invention is described in claim 2.

By providing a variable current source for the bypass circuit a simple implementation is obtained.

Another characteristic feature of the present invention is mentioned in claim 3.

The regulation step thereby determines the amount of current which is bypassed by the variable current source.

The present invention also relates to an inductor coil circuit for realising the aforementioned method, as is described in claims 4, 5 and 7. Claim 6 further describes a simple implementation of the variable current source through which the DC current is bypassed Another characteristic feature of the present invention is mentioned in claim 8.

The regulation circuit is thereby such as to create a DC voltage drop across the variable current source. This voltage drop is required e.g. in order to be able to implement the (active) gyrator circuit and enable a DC current flow through it.

The regulation circuit can be a capacitor or a resistor, as is mentioned in claims 9 and 10. They both describe a very simple implementation of the regulation circuit. The capacitor implementation further has the advantage of providing a clear low-impedance path for the high frequencies towards the coil, and to conduct all DC-current to the bypass.

The subject method is as well applicable to and the invention as well relates to a circuit including a series connection of coils, such as for instance a filter circuit, as is further stated in claim 11.

One or more bypass circuits can therefore be provided, either across each individual coil, or either across one or more coils in series. The most cost-effective solution of course exist when one bypass circuit is foreseen to bypass the series connections of all coils.

It is to be noticed that the term ‘coupled’, used in the claims, should not be interpreted as being limitative to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

It is to be noticed that the term ‘comprising’, used in the claims, should not be interpreted as being limitative to the means listed thereafter. Thus, the scope of the expression ‘a device comprising means A and B’ should not be limited to devices consisting only of components A and B. It means that with respect to the present invention, the only relevant components of the device are A and B.

The above and other objects and features of the invention will become more apparent and the invention itself will be best understood by referring to the following description of an embodiment taken in conjunction with the accompanying drawings wherein

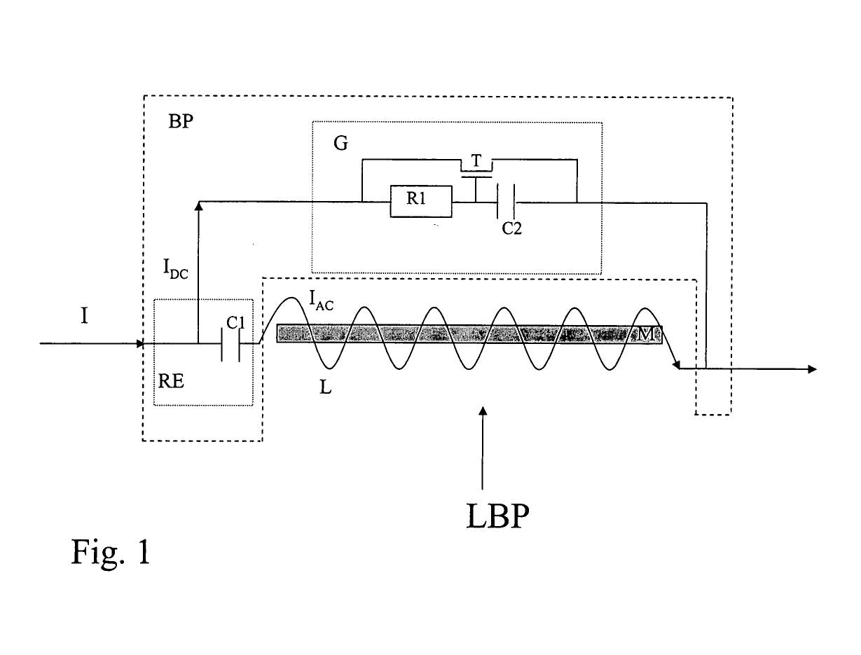

FIG. 1 gives a basic scheme of an inductor circuit LBP according to the invention, and

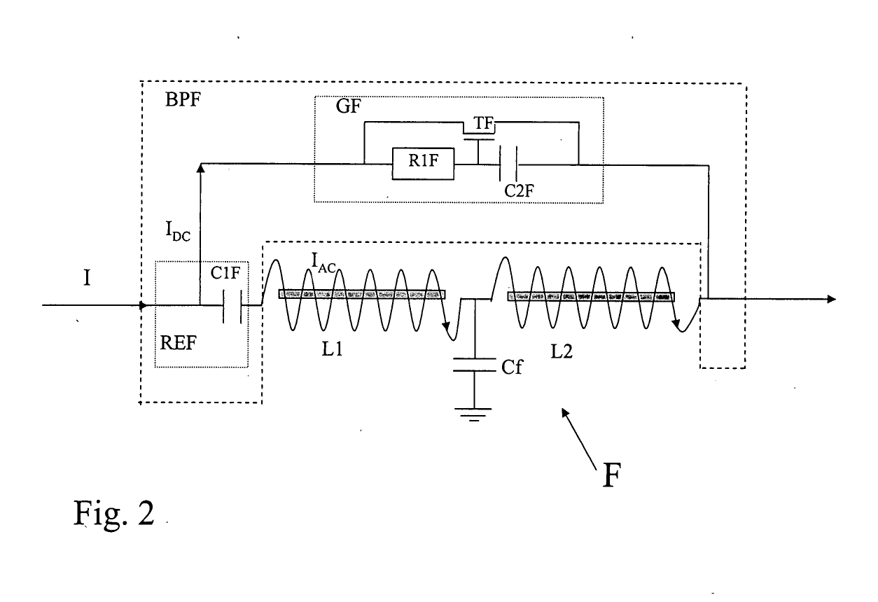

FIG. 2 gives a basic scheme of a filter circuit F including a series connections of coils in which the invention is as well implemented.

FIG. 1 shows a inductor circuit LBP including a conventional coil L wound around a magnetic core M, to which an input current I is provided. Across and in parallel with the coil a bypass circuit BP is present through which the DC current which would normally flow through the coil, is now bypassed. This bypassing of the DC current is further obtained by means of a regulating circuit RE, which splits the current which is fed to the coil into a dc and an ac component, the dc component IDC being guided within the bypass circuit, and the ac component I_{AC} being guided to the coil itself. The regulation circuit is such as to create a DC voltage drop across the bypass circuit. The circuit of the bypass circuit through which the DC current is really bypassed further has to be low-impedant for DC. In this way most of the DC current flows through the bypass circuit, whereas the normal ac current flows through the coil. Examples of such regulation circuits are a simple capacitor, as denoted C1 in FIG. 1, or a resistor which may take the place of the capacitor C1 in FIG. 1. The impedance of the resistor has to be such as to block a large part of the DC current, which accordingly has to flow then to the parallel circuit across the coil and resistor.

The bypass circuit further comprises a variable dc current source such as for instance an active inductor G based on a gyrator concept. A simple embodiment is shown in FIG. 1, whereby this gyrator circuit G consists of a series coupling of a resistor R1 and a capacitor C2, the junction point between these components being coupled to the control electrode of an active device T such as a transistor. The two main current conducting terminals of this active device T are coupled to the respective other terminals of the resistor and the capacitor. This gyrator together with the capacitor C1 of the provides a self-regulating bypass circuit which conducts all of the DC current via the gyrator since the capacitor C1 blocks all DC current to the coil. In case of a resistor instead of C1, the DC blocking is not complete, but by selecting the value of the series resistor to the coil to be significantly higher than that of the gyrator, only a limited amount of DC current flows through the coil itself.

This invention is as well applicable to other circuits, such as for instance filter circuits, including a series connection of several coils such as shown in FIG. 2 which shows a simple filter consisting of inductors L1 and L2 and a capacitor Cf. For such a circuit, saturation of the magnetic core of either coil L1 or L2 can be avoided by either providing a separate bypass circuit per coil such as shown in FIG. 1, or by either providing one bypass circuit across several coils. The latter situation is shown in FIG. 2 where one single bypass circuit BPF comprising a regulating circuit REF consisting of capacitor C1F, a gyrator circuit BPF consisting of resistor R1F, Capacitor C2F and transistor TF is provided for the two coils. This principle is also applicable to higher order filters, including more than 2 coils, each of them being intersected by a capacitor. Advantages of such a solution are that, due to less saturation in the coil, smaller magnetic cores can be used, resulting in less volume for the filters, such as splitter circuits. The extra circuitry required for the bypass circuit does not counteract this advantage since such an active inductor or gyrator principle, together with the capacitor can be integrated on an integrated circuit.

While the principles of the invention have been described above in connection with specific apparatus, it is to be clearly understood that this description is made only by way of example and not as a limitation on the scope of the invention, as defined in the appended claims.

1. Method to avoid saturation of the magnetic core (M) of an inductor coil (L), said method including the steps of providing a bypass circuit (BP) across said inductor coil (L) for bypassing a DC current to said coil.

2. Method according to claim 1, wherein said step of bypassing said DC current is performed via the provision of a variable current source.

3. Method according to claim 1, wherein said method further includes a step of providing a regulation circuit (RE) for regulating the level of the DC current which is bypassed.

4. Inductor circuit (LBP) including a coil winding (L) around a magnetic core (M)
characterised in that
said inductor circuit (LBP) further includes a bypass circuit (BP) for bypassing a DC current through said coil winding (L).

5. Inductor circuit (LBP) according to claim 4, wherein said bypass circuit (BP) comprises a variable current source.

6. Inductor circuit (LBP) according to claim 5, wherein said bypass circuit (BP) includes a gyrator circuit (R1,C2,T).

7. Inductor circuit (LBP) according to claim 4, wherein said inductor circuit further includes a regulation circuit (RE) for regulating the level of the DC current (I_{DC} ) which is bypassed.

8. Inductor circuit (LBP) according to claim 7, wherein said regulation circuit (RE) includes means (C1) to create a DC voltage drop across said variable current source.

9. Inductor circuit according to claim 9, wherein said regulation circuit includes a capacitor (C1).

10. Inductor circuit according to claim 9, wherein said regulation circuit includes a resistor.

11. Circuit (F) including a series connection of coils (L1, L2), characterised in that said circuit (F) further includes at least one bypass circuit (BPF) according to claim 5 across one or more of said coils (L1,L2).
